(19) United States
(12) Patent Application Publication
(10) Pub. No.: US 2012/0032609 A1
(43) Pub. Date: Feb. 9, 2012

(54) DEVICE FOR REGULATING THE LUMINOUS INTENSITY IN FLUORESCENT LAMPS WITH AN ELECTROMAGNETIC REACTANCE AND A STARTER, AND LIGHTING SYSTEM WHICH COMPRISES SAID DEVICE

(75) Inventors: Roque Bonal Rubio, Albacete (ES); Antonio Saez Castillo, Albacete (ES); Emilio Gomez Lazaro, Albacete (ES)

(73) Assignees: Universidad de Castilla-La Mancha, Albcete (ES); Villarrus, S.L., Albacete (ES)

(21) Appl. No.: 13/141,770

(22) PCT Filed: May 7, 2009
(86) PCT No.: PCT/ES09/70147

§ 371 Date: Oct. 4, 2011

(30) Foreign Application Priority Data
Dec. 26, 2008 (ES) P200803717

(51) Int. Cl. H05B 37/02; H05B 41/36

(52) U.S. Cl. 315/294; 315/291

(57) ABSTRACT

The present invention relates to a device for regulating light intensity in fluorescent lamps with an electromagnetic ballast and starter and a lighting system comprising said device, comprising at least one fluorescent lamp comprising a fluorescent tube (1) which is operatively connected in parallel with a starter (3) and in series with an electromagnetic ballast (4), wherein the device comprising a regulating module (5) connected in series between said fluorescent lamp and a voltage source configured to supply said fluorescent lamp, said regulating module (5) being configured to regulate the light intensity of the fluorescent lamp, regulating its electric consumption.

### OBJECT OF THE INVENTION

The present invention relates to a device for regulating light intensity in fluorescent lamps with an electromagnetic ballast and starter and to a lighting system comprising said device which can be used in the electrical industry, and more specifically in the area of lighting systems, which allows simply regulating the light intensity of currently existing fluorescent lamps by means of a low cost device.

### BACKGROUND OF THE INVENTION

The considerable electric consumption, particularly in developed countries, is known today. Within said consumption, lighting has a specific importance as fluorescent lighting is the most widespread lighting system.

FIG. 1 shows the circuit diagram of the currently existing conventional fluorescent lighting system provided with an electromagnetic ballast and starter. This is the most prevalent system and is found in 90% of current-day facilities.

Today the operating principle of a fluorescent lamp requires ionizing a gas inside the fluorescent tube in order to be turned on. In conventional installations today depicted in FIG. 1, the starter produces a spark through the filaments of the tube such that the gas is ionized and is kept ionized by the primary circuit through the electromagnetic ballast having the basic function of compensating for the 50 Hz frequency interruptions.

However, European Union Directive 2000/55/CE 18/09 relating to lighting systems of this type prohibits the use of standard electromagnetic ballasts as of November 2005 and those causing the greatest losses as of May 2002.

On the other hand, these conventional installations have three fundamental drawbacks. The first is that that they consume 300% more than the rated consumption indicated by manufacturers for the lamp when they are turned on. The second is that during normal operation, the consumption is sometimes 100% higher than the rated consumption. The third drawback is that in these conventional systems it is not possible to regulate the brightness, i.e., the degree of light intensity.

The direct cause of the first two deficiencies is the electromagnetic ballast, and it is known by the installers, manufacturers and other agents of the sector that the real consumption values are much higher than the rated values indicated by the manufacturers of fluorescent tubes. In fact, to scale the section of the feed lines of said tubes in the calculations made in installations having fluorescent tubes, the rated power is multiplied by a factor of 1.62 for the purpose of considering the power factor in the start-up.

Therefore the need to provide means allowing an electrical energy savings without jeopardizing the normal installation operating conditions, for example in large commercial facilities or workplaces that are lighted by fluorescent tubes where, because of construction conditions, there is natural lighting that varies throughout the day as a consequence of the exterior environmental conditions exists, and because of the variation of sunshine at different times of the year.

In turn, there are installations in which the operating conditions, and not just the conditions outside the installation, determine certain hours of inactivity where an illumination level as high as in normal working conditions is not necessary, for example, the lighting for cleaning the central offices or selective lighting installations according to whether or not there is activity, such as in a public parking lot at night for example.

For the purpose of at least partially resolving the drawbacks described above, a system called electronic ballast came about which allows regulating light intensity, although its excessive cost is an enormous drawback, plus its installation requires changes in the existing system be made, which additionally makes its installation more expensive, not only because of the materials but also because of the labor, therefore according to the type of facility in certain cases, such adaptation is not viable.

In the case of installations with an electronic ballast, to ionize the gas without needing to use a starter it is necessary to have an electronic circuit increasing the voltage enough to ionize the gas, after that point having an operation that is similar to conventional systems, with the only difference being that in installations with an electronic ballast the consumption is maintained close to the rated consumption both in the start-up and during normal operation.

### DESCRIPTION OF THE INVENTION

A first aspect of the present invention relates to a device for regulating light intensity in fluorescent lamps with an electromagnetic ballast and starter comprising at least one fluorescent lamp in turn comprising a fluorescent tube that is operatively connected in series with a starter and in series with an electromagnetic ballast through terminals that said fluorescent tube comprises at its ends. The starter is connected with a terminal located at each end of the fluorescent tube.

According to the invention, the device comprises a regulating module connected in series between said fluorescent lamp and a voltage source configured to supply the fluorescent lamp, said regulating module being configured to regulate the light intensity of the fluorescent lamp, regulating its electric consumption, i.e., reducing said electric consumption.

The possibility of the regulating module comprising a switch in turn comprising a plurality of discrete positions operatively associated with a plurality of longitudinal positions of an electromagnetic coil is contemplated, said positions of said switch defining a plurality of light intensity states of the fluorescent lamp.

Preferably, passing between two consecutive positions in the switch is done without opening the electric circuit supplying the fluorescent lamp.

The invention can be used for any type of fluorescent lamp, for any power or manufacture model existing today. The configuration of the coil is traditional for autotransformers considering for the calculation of the wire that its thickness is determined by the consumption of the electrical circuit in which it is placed, 20% oversizing being advisable as an assurance. For example, a 30 W lamp needs a wire that withstands 150 mA, including the 20% additionally needed section to withstand a 3 A current through the coil.

To prevent the tube from turning off in the moment of changing the coiling, the switch, regardless of whether it is a dial switch, pressure switch or an electronic system, is configured to close one circuit before opening the next one.

On the other hand, the possibility of the regulating module comprising an integrated circuit in turn comprising a plurality of discrete positions operatively associated with a plurality of longitudinal positions of an electromagnetic coil is contemplated, said discrete positions defining a plurality of light intensity states of the fluorescent lamp.

When the switch is connected, the entire system is supplied in the same way that a conventional lamp is turned on, supplying the direct current for the integrated circuit, connecting a capacitor so that the fluorescent tube remains on during the changes and connecting a first output with a zero ohm resistor so that the fluorescent tube is turned on at 100% intensity. Then, as the switch of the electronic circuit is operated, the outputs are changed.

A second aspect of the invention relates to a lighting system comprising at least one fluorescent lamp and at least one device for regulating light intensity as previously described, the possibility of the device being configured to simultaneously regulate the light intensity of a plurality of fluorescent lamps being contemplated.

The device of the invention allows regulating up to 70% of the brightness in conventional fluorescent tube installations provided with an electromagnetic ballast and starter. The present invention regulates the brightness of a single tube up to a set formed by a plurality of fluorescent tubes provided with an electromagnetic ballast and starter.

In view of the needs described above, the device of the invention is efficient, economizing and perfectly compatible with the normal operating conditions of the activity, such that any installation based on fluorescent tubes with an electromagnetic ballast and starter have the possibility, by means of using the invention, of solving in the most cost-effective manner possible the regulation problems described above without needing considerable alterations in the installation.

Like electronic ballasts, the invention operates under the principle that at lower brightness, less electric consumption.

The invention contemplates multiple configuration possibilities of the regulation control. The light intensity can be regulated in several ways, manually and/or automatically, and with automatic regulation it can be timed or self-controlled.

In relation to the means for acting on the device referring to turning them on and off, it is contemplated that said means consist of a presence detector, a timer or any other means configured to automatically turn the installation on or off, said means replacing the common switch of the electrical circuit.

On the other hand, in relation to the regulating means, the invention contemplates the incorporation in the manual means regulating module.

The possibility that the regulating means are automatic is also contemplated, automating what has been described above, for example in the case of the switch, placing a servomotor in the regulating module, said servomotor being configured to turn the selector to the position commanded by the brightness detector, i.e., a suitably programmed common brightness detector on the market, configured to detect the changes in the exterior lighting and commanding the servomotor to maintain a fixed lighting level in the installation.

The lighting system of the invention is highly versatile because in addition to conventional fluorescent lamps, the device is configured to regulate light intensity in any type of lighting system selected from conventional or electronic fluorescence, incandescence, dichroic, halogen, high pressure discharge lamps, induction lamps, LED lamps, with the necessary condition of not interrupting the circuit of the selector switch upon changing from one terminal to another of the coil, where the coil capacity is determined by the power of the lighting system to be regulated. As stated, the movement of the regulator can be: manual, motor-driven, automatic, timed, by remote control or self-controlled by a programmed system.

### DESCRIPTION OF THE DRAWINGS

To complement the description that is being made and for the purpose of helping to better understand the features of the invention according to a preferred practical embodiment thereof, a set of drawings is attached as an integral part of said description in which the following has been depicted with an illustrative and non-limiting character:

FIG. 1 shows a circuit diagram of a conventional currently existing installation of a fluorescent lamp comprising an electromagnetic ballast and starter.

FIG. 2 shows a circuit diagram of an installation such as that of the preceding figure comprising the device of the invention.

FIG. 3 shows a circuit diagram of an embodiment of the invention comprising a switch and an electromagnetic coil.

FIG. 4 shows a circuit diagram of an embodiment variant of the invention comprising an integrated circuit.

FIG. 5 shows a circuit diagram of an installation with the device of the invention, its regulation capacity in multiple lighting systems and power rating being depicted.

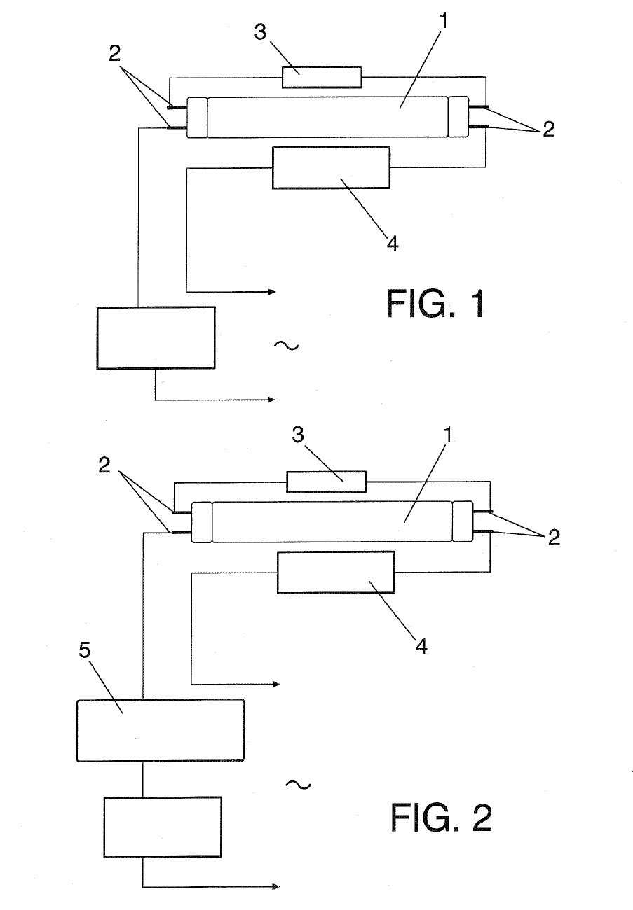

### PREFERRED EMBODIMENT OF THE INVENTION

In view of the mentioned figures, it can be observed how in one of the possible embodiments of the invention the electronic device for regulating light intensity in fluorescent lamps with an electromagnetic ballast and starter proposed by the invention comprises a fluorescent lamp in turn comprising a fluorescent tube (1) which is operatively connected in parallel with a starter (3) and in series with an electromagnetic ballast (4) through terminals (2) which said fluorescent tube has at its ends.

As can be seen in said drawings, the device comprises a regulating module (5) connected in series between the fluorescent lamp and a voltage source configured to supply said fluorescent lamp, said regulating module (5) being configured to regulate the light intensity of the fluorescent lamp, thereby reducing its electrical consumption.

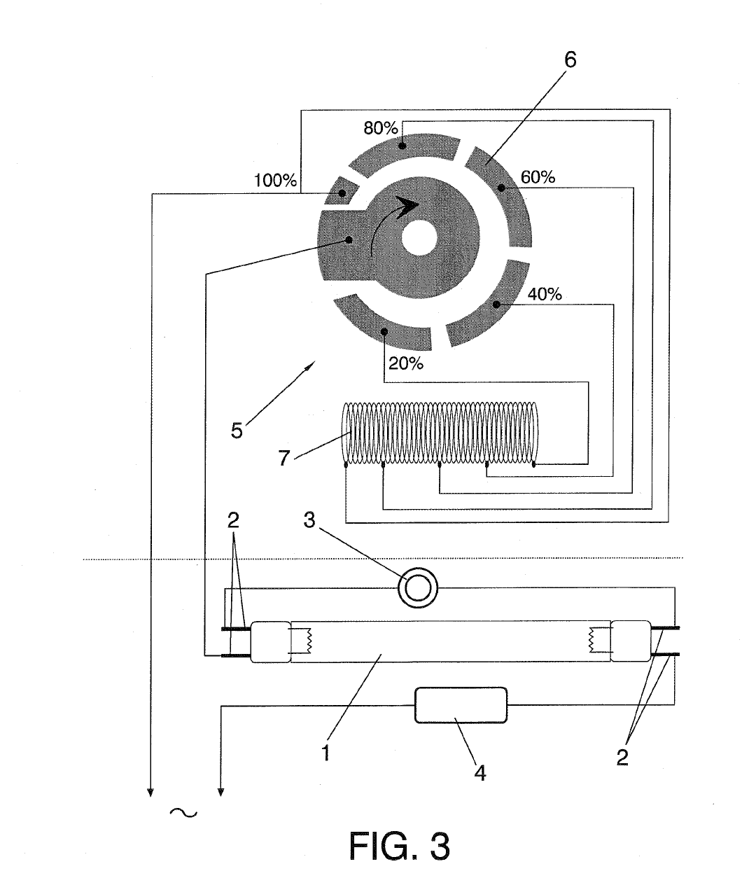

According to an embodiment of the device depicted in FIG. 3, the regulating module (5) comprises a switch (6) in turn comprising a plurality of discrete positions operatively associated with a plurality of longitudinal positions of an electromagnetic coil (7), said positions of said switch (6) defining a plurality of light intensity states of the fluorescent lamp, such that passing between two consecutive positions of the switch (6) is done without opening the electrical circuit supplying the fluorescent lamp. FIG. 3 shows a regulating module (5) allowing 5 brightness levels. The configuration of the electromagnetic coil (7) is the traditional configuration for autotransformers.

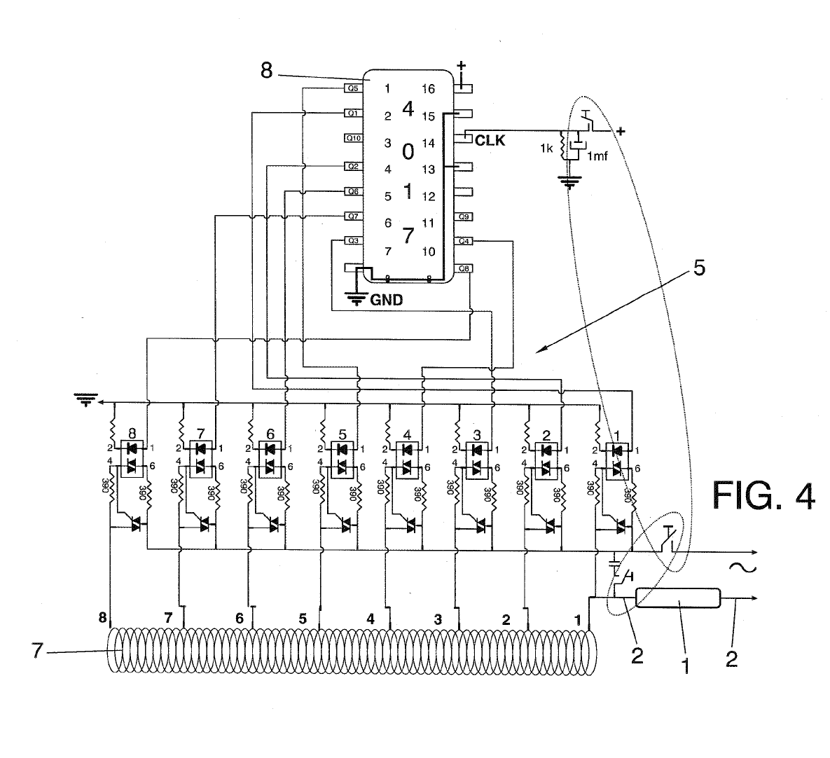

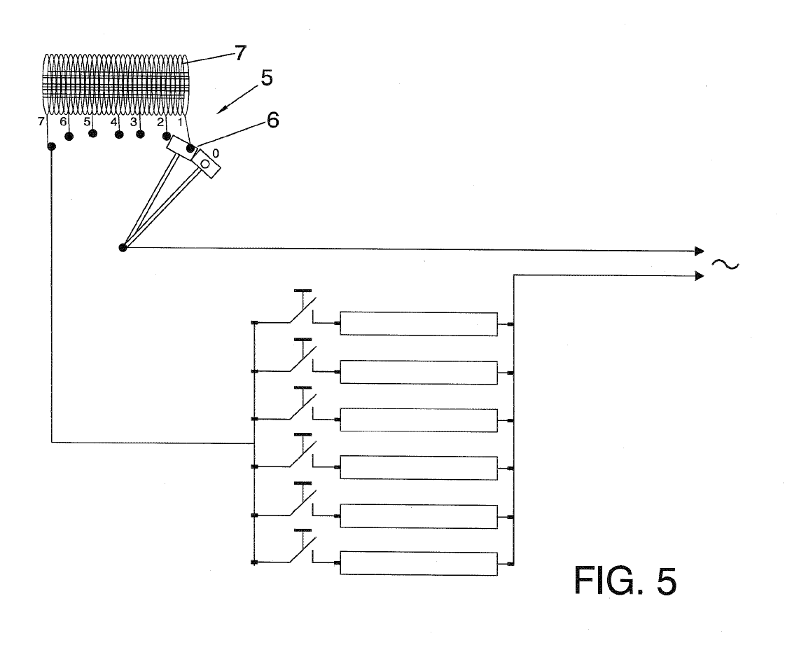

On the other hand, according to a variant of the device depicted in FIG. 4, the regulating module (5) comprises an integrated circuit (8) in turn comprising a plurality of discrete positions operatively associated with a plurality of longitudinal positions of an electromagnetic coil (7), said discrete positions defining a plurality of light intensity states of said the fluorescent lamp.

When the switch is connected, the entire system is supplied in the same way that a conventional lamp is turned on, supplying the direct current for the integrated circuit (8), for example a 4017 integrated circuit, connecting a capacitor so that the fluorescent tube remains on during the changes and connecting a first output with a zero ohm resistor so that the fluorescent tube is turned on at 100% intensity. Then, as the switch of the electronic circuit is operated, the outputs are changed.

In relation to the regulating means, the invention incorporates in the manual means regulating module possibly being either a system which positions the brightness level for example by turning the selector, or in the case of comprising the integrated circuit, by pushing the T key as many times desired until achieving the desired brightness level, i.e., when pushed the first time, it turns on at 100% and when successively pushed it is gradually reduced step by step in 8 levels until being turned off when pushed for the ninth time, always being turned on at 100% brightness.

In view of this description and set of drawings, the person skilled in the art will be able to understand that the embodiments of the described invention can be combined in many ways within the object of the invention. The invention has been described according to several preferred embodiments thereof, but for the person skilled in the art it will be evident that multiple variations can be introduced in said preferred embodiments without exceeding the object of the claimed invention.

1. Device for regulating light intensity in fluorescent lamps with an electromagnetic ballast and starter, comprising at least one fluorescent lamp comprising a fluorescent tube (1) operatively connected in parallel with a starter (3) and in series with an electromagnetic ballast (4), characterized in that it comprises a regulating module (5) connected in series between said at least one fluorescent lamp and voltage source configured to supply said at least one fluorescent lamp, said regulating module (5) being configured to regulate the light intensity of said at least one fluorescent lamp, regulating the electric consumption of said at least one fluorescent lamp, wherein said
regulating module (5) comprises a switch (6) comprising a plurality of discrete positions operatively associated with a plurality of longitudinal positions of an electromagnetic coil (7), said positions of said switch (6) defining a plurality of light intensity states of said at least one fluorescent lamp.

2. Device for regulating light intensity in fluorescent lamps with an electromagnetic ballast and starter according to claim 1, characterized in that passing between two consecutive positions in the switch (6) is done without opening the electric circuit supplying said at least one fluorescent lamp.

3. Device for regulating light intensity in fluorescent lamps with an electromagnetic ballast and starter according to claim 1, characterized in that the regulating module (5) comprises an integrated circuit (8) comprising a plurality of discrete positions operatively associated with a plurality of longitudinal positions of an electromagnetic coil (7), said discrete positions defining a plurality of light intensity states of said at least one fluorescent lamp.

4. Lighting system comprising at least one fluorescent lamp, characterized in that it comprises a least one device for regulating light intensity according to claim 1.

5. Lighting system according to claim 4, characterized in that the device for regulating light intensity allows simultaneously regulating the light intensity of a plurality of fluorescent lamps.

6. Lighting system according to claim 4, characterized in that it comprises any type of lighting system selected from conventional or electronic fluorescence, incandescence, dichroic, halogen, high pressure discharge lamps, induction lamps or LED lamps.
